(19) United States
(12) Patent Application Publication
(10) Pub. No.: US 2007/0147057 A1
(43) Pub. Date: Jun. 28, 2007

(54) Seat post of a bicycle

(75) Inventor: Nai-chien Mohr, Taipei (TW)

Correspondence Address: BACON & THOMAS, PLLC, 625 SLATERS LANE, FOURTH FLOOR, ALEXANDRIA, VA, 22314, US

(73) Assignee: DEM Inc., Taipei City (TW)

(21) Appl. No.: 11/500,308

(22) Filed: Aug. 8, 2006

(30) Foreign Application Priority Data
Dec. 28, 2005 (TW) 094222834

(51) Int. Cl. B62J 6/00

(52) U.S. Cl. 362/473

(57) ABSTRACT

The present invention discloses a bicycle seat post combining with a caution device. Mainly an end of the bicycle seat post receiving a saddle has a bent section. The bent section is formed to be as a cantilever, a tail end of the cantilever is set a lid in combination with a caution light or a reflector, and therefore the caution light or the reflector is able to be installed into a containing room provided by the lid without any connecting component.

### FIELD OF THE INVENTION

The present invention relates to a seat post of a bicycle, more particularly to a seat post combining a caution device such as a caution light and a reflector so that the driving safety can be assured because the caution light and the reflector will have the alarm function for people or vehicles.

### BACKGROUND OF THE INVENTION

For the driving safety of the bicycle, the bicycle usually installed all kinds of caution devices such as the caution light or the reflector on the bicycle frame to draw the attention of pedestrians and vehicles. In order to draw the attention of the vehicles behind the bicycle, most of the users will choose to install the caution device on the rear frame of the bicycle.

It is a common way to install the caution device on the rear side of the seat post. In the past, we saw that the caution device itself has a clamping element or other kinds of connecting components to fix on the seat post. However, it is more troublesome to use the connecting component indirectly joining the seat post when installing. Besides, improper installation or the bicycle frame vibrating for a long time would cause the slipping condition of the connecting component and the seat post so that the installation angle or the installation height of the caution device would be away from the anticipant position. It is possible for the caution device departing to the position that the caution device can not work effectively to the behind vehicles.

### SUMMARY OF THE INVENTION

In view of the shortcomings existing of the caution device installing on the bicycle by the connecting component, the present invention provides a solution to install the caution device on the seat post without connecting components. It is more convenient and beautiful.

The present invention has a bent section located on one end of the seat post for receiving a saddle and formed a cantilever. One end of the cantilever has a lid for coupling the caution light or the reflector. The caution light or the reflector can directly couple to a containing room of the lid without any connecting component so that the shortcomings existing of the caution device indirectly installing on the seat post by the connecting component can be avoid.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a side view of a seat post applied to a bicycle of the present invention and having a caution device.

FIG. 2 is a schematic view from the back side of the seat post of the present invention.

FIG. 3 is a cross-section view of a preferred embodiment of the seat post of the present invention coupling with the caution device.

FIG. 4 is a cross-section view of another preferred embodiment of the seat post of the present invention coupling with the caution device.

FIG. 5 is an exploded view from the disclosed structure of FIG. 4.

### DETAILED DESCRIPTION OF THE PREFERRED EMBODIMENTS

For further understanding about the goal, structure, characteristics and the function of the present invention, the detail description with the drawings is stated below.

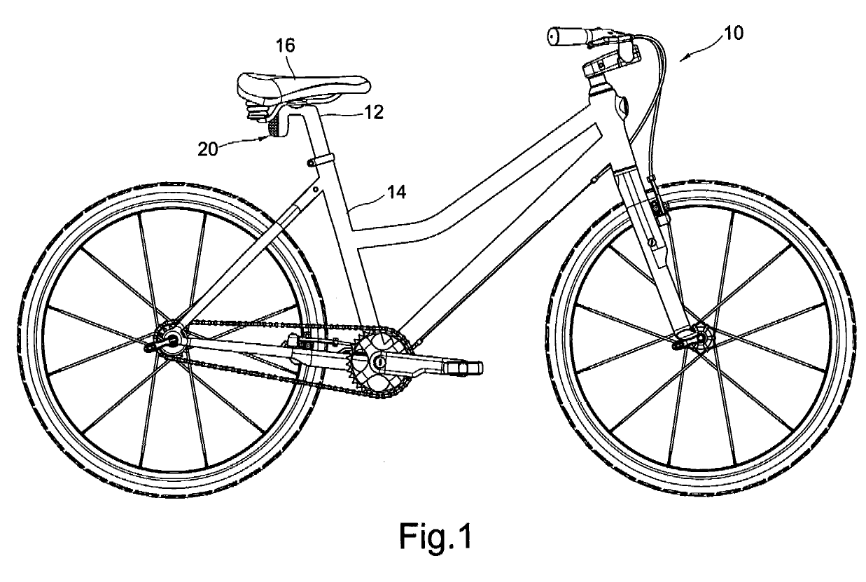

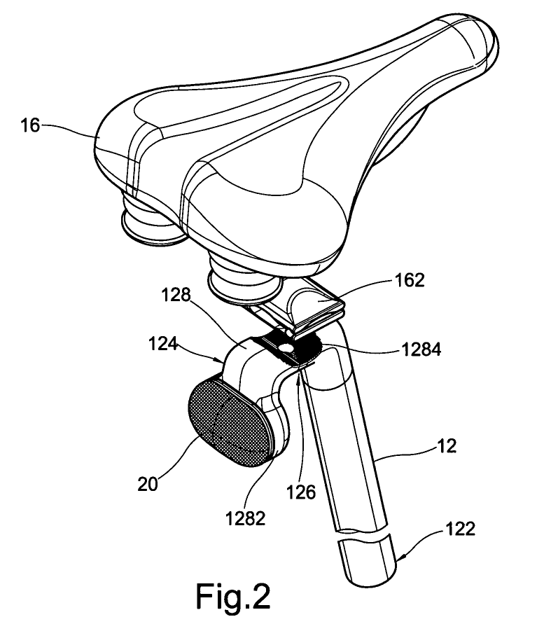

Referring to FIG. 1, the present invention has a bicycle 10 and a caution device 20 coupled on a seat post 12 of the bicycle 10. Please also refer to FIG. 2. The seat post 12 is a hollow tube of a solid rod between a bicycle frame 14 and a saddle 16. The seat post has a first end 122 for receiving the bicycle frame 14 and a second end 124 for receiving the saddle 16. The second end 124 has a bent section 126 to form a cantilever 128. An end of the cantilever 128 has a lid 1282. The caution device 20 is coupled in the lid 1282. The caution device includes but dose not limit to a caution light, a reflector, and other device having warning effect by using light, reflection or other way.

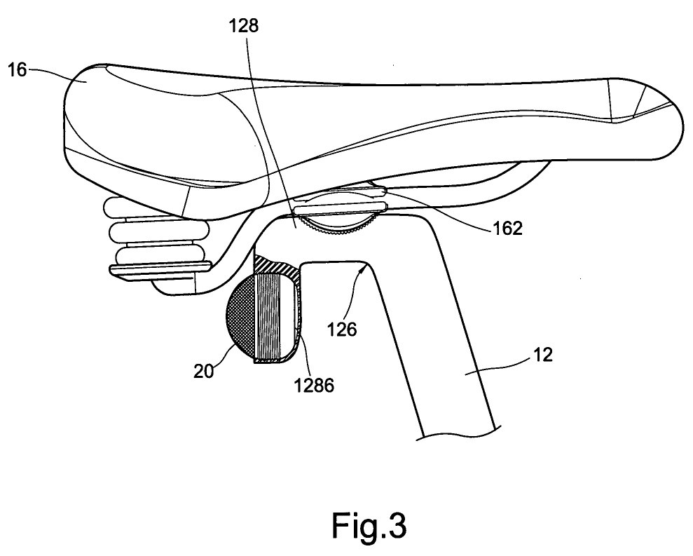

The seat post 12 has the cantilever 128 formed by bending and extending to the rear side of the bicycle frame 14 in the horizontal direction. The upper surface of the cantilever 128 has a surface 1284 to receive a connection assembly 162 under the saddle 16. A containing room 1286 having an opening is located on the lid 1282 of a tail end of the cantilever 128. The inner space of the containing room 1286 and the size of the opening depend on the size or the standard of the caution device 20. When practicing, as shown in FIG. 3, the caution device 20 installed in the containing room 1286 of the lid 1282 is a caution light or a reflector which can be fixed in the containing room 1286. The caution device 20 and the containing room 1286 can be fixed together by the screw, the buckle or other mechanical coupling way. Also, the caution device 20 can be stuck and fixed in the containing room 1286 by the glue.

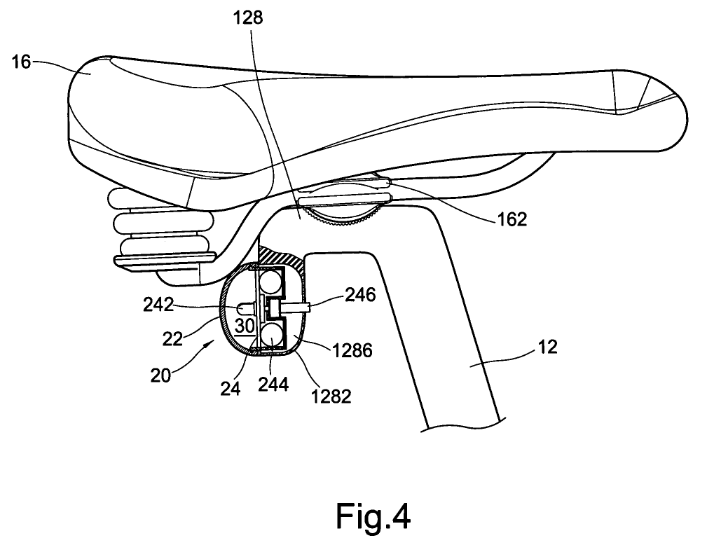

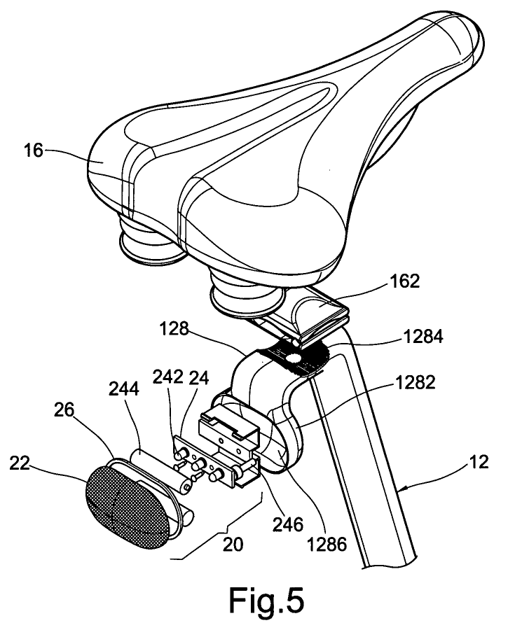

The containing room 1286 of the lid 1282 can be used as a portion of covering a housing of the caution device 20. As shown in FIG. 4 and FIG. 5, take a caution light for example, the caution device includes a lampshade 22, a circuit board 24 having a light-emitting element 242, a battery 244, and a power switch 246. The lampshade 22 and the lid 1282 can be coupled to form an inner containing room 30. The circuit board 24, the battery 244, and the power switch 246 can be arranged in the inner containing room 30. In order to prevent the rain and the dust from entering the inner containing room 30, there is a sealed strip 26 located on the contact portion of the lampshade 22 and the lid 1282 to ensure that the rain and the dust will not enter via the chink of the contact portion.

According to the above description, the seat post 12 has the function for the caution device installing and coupling. The present invention can fix and couple the caution device 20 on the seat post 12 without any connecting component totally. Compare to the conventional invention, the present invention dose not have those shortcomings because of using the connecting component.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A bicycle seat post combining with a caution device, comprising:
a first end for receiving a bicycle frame and a second end for receiving a saddle, the second end having a bent section to form an cantilever, and an end of the cantilever having a lid for coupling the caution device.

2. The bicycle seat post of claim 1, wherein the cantilever extends in the horizontal direction.

3. The bicycle seat post of claim 1, wherein the cantilever has a surface to receive the saddle.

4. The bicycle seat post of claim 1, wherein the lid is located on a tail end of the cantilever and has a containing room for the caution device installing and coupling.

5. The bicycle seat post of claim 1, wherein the caution device is a caution light.

6. The bicycle seat post of claim 1, wherein the caution device is a reflector.
